(19) United States
(12) Patent Application Publication
(10) Pub. No.: US 2009/0176039 A1
(43) Pub. Date: Jul. 9, 2009

(54) Image Transfer Sheet and Method Utilizing a Rubber Based Hot Melt Adhesive

(76) Inventor: Oscar af Strom, Atizapan (MX)

Correspondence Address: PATWRITE LLC, 408 W. MAIN ST., MARSHALLTOWN, IA, 50158-5759, US

(21) Appl. No.: 12/171,674

(22) Filed: Jul. 11, 2008

Related U.S. Application Data
(63) Continuation-in-part of application No. 10/783,971, filed on Feb. 20, 2004, now abandoned.
Application No. 10/783,971 is a continuation-in-part of application No. 11/465,446, filed on Aug. 17, 2006.
(60) Provisional application No. 60/595,921, filed on Aug. 17, 2005.
(60) Provisional application No. 60/743,789, filed on Mar. 27, 2006.
(60) Provisional application No. 60/804,756, filed on Jun. 14, 2006.

(51) Int. Cl. B41M 5/40

(52) U.S. Cl. 428/32.77

(57) ABSTRACT

The present invention provides a transfer sheet on which the image to be transferred may be applied directly on one side of the sheet, by any known means, e.g. printing, copying, drawing, painting etc., and which may be applied on practically any surface by use of an adhesive located on the opposite side either as a sticker or an iron-on decal. The transfer sheet comprises an image absorbing layer in contact with a plastic film layer, then a rubber based hot melt adhesive layer and finally a protective liner. Another embodiment of the present invention comprises an image absorbing layer in contact with a plastic film layer, then a rubber based hot melt adhesive layer and finally a coating layer. Yet another embodiment of the present invention comprises an image absorbing layer in contact with a rubber based hot melt adhesive layer, then a plastic film layer with a liner.

### RELATED APPLICATIONS

This is a continuation in part of U.S. patent application Ser. No. 10/783,971, filed Feb. 20, 2004 and U.S. patent application Ser. No. 11/465,446, filed Aug. 17, 2006. 5, 2001 U.S. Pat. No. 6,173,650, which in turn claims priority to U.S. provisional patent applications 60/595,921, filed Aug. 17, 2005, 60/743,789, filed Mar. 27, 2006 and 60/804,756 filed Jun. 14, 2006 the complete disclosures of each of which are hereby incorporated by reference.

### BACKGROUND OF THE INVENTION

Surface decoration by means of image transfer is an old craft, for which patents were issued as early as the 19th century. Transfers made during that era were made through a direct process, i.e. an image was printed or painted on a piece of paper that was coated with a suitable emulsion. The coated paper was then positioned so that the emulsion came in contact with the substrate. When the emulsion dried, the image paper backing was washed away; leaving the image adhered to the substrate. Many beautiful decorations were prepared in this manner. It should be noted that the transferred image obtained by this direct method appeared as a mirror image of the original. Because of this, it was necessary to print the transfer images in reverse to obtain an accurate image.

This method was improved by printing the image on a paper coated with a layer of water soluble adhesive, which made paper removal faster and easier. Later, instead of being printed on a water soluble adhesive, the image was printed on a paper coated with a layer of a material such as silicone that could easily be dry released. Furthermore, instead of using a wet adhesive to paste the print to the substrate, dry heat sensitive coatings were applied over the image, which were printed over the dry release layer. The printed and coated paper was then positioned with the heat sensitive coating in contact with the substrate. Heat and pressure were applied over the paper fusing the image and the coating together. When cool, the release coated paper was peeled off, and the transfer was complete.

Later improvements to the direct transfer method included coating paper with a release layer and then applying a heat sensitive coating over the release layer. The image was printed on the heat sensitive layer and then transferring as discussed above.

The disadvantages of direct transfer sheets described above include the following. The image has to be printed in reverse, and the transfer has to be heat fused, which requires relatively high pressure and high temperature. This excludes transfers to a number of substrates, such as walls, windows, scrap books, etc. Furthermore, only a fraction of these sheets may be hand colored and then transferred.

### SUMMARY OF THE INVENTION

The present invention provides a transfer sheet on which the image to be transferred may be applied directly on one side of the sheet, by any known means, e.g. printing, copying, drawing, painting etc., and which may be applied on practically any surface by use of an adhesive located on the opposite side either as a sticker or an iron-on decal. The transfer sheet comprises an image absorbing layer in contact with a plastic film layer, then a rubber based hot melt adhesive layer and finally a protective liner. Another embodiment of the present invention comprises an image absorbing layer in contact with a plastic film layer, then a rubber based hot melt adhesive layer and finally a coating layer. Yet another embodiment of the present invention comprises an image absorbing layer in contact with a rubber based hot melt adhesive layer, then a plastic film layer with a liner.

In my research I have demonstrated the ability of a rubber based hot melt adhesive, when combined with a plastic film in a composite sheet, to migrate into a substrate. Additionally, it was demonstrated that when heated, this ability may be utilized for heat application of images transferred from paper. In my Provisional Applications, I have also demonstrated that the strength of the bonds of an adhesive may be increased by heating. The present invention is an application of this quality of the adhesive for the purpose of transferring images which have been applied to an image absorbing layer, either on the plastic film, or on the surface of the adhesive. Accordingly, the image is first obtained by any known method, e.g. by printing, copying, rubber stamping, drawing and painting, etc., and then transferred to practically any substrate by means of the adhesive, located on the composite sheet opposite side. The transfer may be accomplished with or without heat pressing.

For this purpose, four different composite sheets have been developed; all of them having a plastic film combined with a rubber based hot melt adhesive and an image absorbing layer.

Sheet 1: Adhesive Transfer Sheet

The first sheet is intended for adhesive application, though a user always has the option of strengthening the bond by heat pressing. The image absorbing layer is applied over the plastic film and a common liner over the adhesive. The image is obtained directly without the need for reverse image. The sheet is applied with the adhesive in contact with the substrate. For many applications, this will be satisfactory. However, when required, the bond may be heated, causing the adhesive to migrate into the cross section of the substrate.

Sheet 2 Heat Transfer Sheet—Wet Release.

This sheet, intended for heat application, also has an image absorbing layer, applied over the plastic film. However, the adhesive is covered by a paper, coated by a layer that will protect and block the adhesive at temperatures below those at which migration occurs, and, when heated, permits the adhesive to migrate through it, into the substrate. There are various coatings which satisfy this requirement, such as the coating of printing papers and layers of acrylics, plastisol and zinc oxide, to mention a few. This sheet also uses a non-reversed image and when transferred, the image is correct. Prior to the transfer, the laminate is submerged for 5 minutes, and the paper base of the coated paper removed, leaving the coated layer protecting the adhesive. The image is cut out and positioned with the coated layer in contact with the substrate. When heated, the adhesive penetrates the coated layer before reaching the surface of the substrate. In this embodiment, the adhesive layer may be heavier than the one in the first sheet, depending on the thickness of the layer which the adhesive will have to penetrate.

Sheet 3: Heat Transfer Sheet—Dry Release.

This sheet is also intended for heat application, and does also have an image absorbing layer applied over the plastic film. The adhesive of this sheet is also covered by a layer with the same properties as the one of Sheet 2a), though the layer adheres to the surface of a dry release sheet such as a silicone coated paper or a release coated polyester film. This sheet also uses a non-reversed image. Prior to the transfer, the image is cut out and peeled off from the release sheet. The sheet is then positioned with the protective layer of the adhesive in contact with the substrate. When heated, the adhesive penetrates the coated layer before reaching the surface of the substrate. In this embodiment, with a thin protective coating, the adhesive layer may be kept the same as the one of the first sheet.

Sheet 4: Reverse Transfer Sheet

The fourth sheet also has an image absorbing layer covering the adhesive; however, the image is received in reverse. The sheet is applied with the image in contact with the substrate, and will appear right. In this embodiment it may be heavier than the one in the first sheet, depending on the thickness of the layer.

All four sheets may be mass produced, using inline coating and lamination machines. However, individual sheets may be obtained by laminating in a heat transfer machine and coating in a screen printing press.

The sheets may also be manufactured, utilizing rolls or sheets with image absorbing layers, such as coated printing papers, zinc oxide coated electrostatic copying paper and inkjet photo papers. Accordingly, the coated paper is first laminated with its coated side in contact with the plastic film, or the adhesive in the fourth embodiment. The paper is then washed away, leaving the coating adhering to the plastic film or the adhesive surface, respectively. Finally, the adhesive and the plastic film are combined.

Many of the steps are common to all four of the embodiments and will be discussed below. Those steps that are unique to each transfer sheet embodiment will be set off by the use of letters A, B, C and D to refer to sheets 1, 2, 3 and 4 respectively.

The transfer sheets are used as follows.
Step 1: An image is created by printing, copying, rubberstamping, drawing or painting on the transfer sheet image absorbing layer. Color laser copying is not recommended since the adhesive will not withstand the high temperature. An outline of a picture may be painted using paints or markers. The image may be colored on the respective transfer paper, ahead of the transfer, or on the transferred image.
Step 2: A. Trim the image.
   B. Apply a piece of a transparent plastic film, coated with removable adhesive, with the adhesive in contact with the image.
   C. Submerge the laminate for approximately 5 minutes, or longer, and peel off the support paper of the coating.
   D. Peel off the image from the release sheet.
   E. Apply by ironing a piece of a release sheet of paper or plastic, preferably transparent, having its release surface coated with a thin plastic film, with the plastic film in contact with the image.
Step 3: Trim the image.
Step 4: Remove the adhesive liner and position the sheet with the adhesive in contact with the desired surface. Rob over the surface of the transfer.
Step 5: Carefully peel off the release sheet. The adhesive transfer is now complete. If extra strength is desired and if the transfer is made on fabric or other material that may be ironed, keep the release sheet and press the transfer for 30 seconds with the iron “cotton” temperature. When cool, peel off the release sheet, which should be saved to be used whenever the transfer is being ironed. Note: While pressing with the iron in contact with the transfer release sheet provides the best migration of some rubber-based hot melt adhesives, like the S-246, pressing over the fabric side is recommended. This not only offers optimal migration, it also protects the image from becoming overheated during the heat pressing.

Press it for 30 seconds with the iron at “cotton” temperature. If the image receptive coating is for inkjet prints, no ironing paper will be required over if the image has been printed in a printer with waterproof inks. Note: While pressing with the iron in contact with the transfer provides the best migration of some rubber-based adhesives, for rubber-based hot melt adhesives, like the S-246, pressing over the fabric side is recommended. This not only offers optimal migration, it also protects the image from becoming overheated during the heat pressing.

Various kinds of image receptive coatings may be utilized. For offset or digital printing of the image, as well as for printing in inkjet printers with waterproof inks, one kind of receptive coating is used, while another kind is used for water soluble inkjet inks, making the image water resistant. However, in order to be machine washed, transfers made with Sheet 1 have to be heat pressed in order for the adhesive to migrate and give the transferred image the required anchorage. If the image has been printed in an inkjet printer using waterproof inks, no further sealing will be required, and the iron may be placed directly on the transferred image. However, if the image was printed in an inkjet printer with water soluble ink, the image has to be covered with a release paper, coated with a suitable sealing layer, such as a thin layer of polyurethane. When cool, the release paper is peeled off, leaving the waterproof sealing layer fused to the image.

Alternate Embodiment

The transfer sheets are used as follows.
Step 1: An image is created by printing, copying, rubberstamping, drawing or painting on the transfer sheet image absorbing layer. Color laser copying is not recommended since the adhesive will not withstand the high temperature. An outline of a picture may be painted using paints or markers. The image may be colored on the respective transfer paper, ahead of the transfer, or on the transferred image.
Step 2: A: Trim the image
   B: Apply a piece of a transparent plastic film, coated with removable adhesive, with the adhesive in contact with the image.
   C: Submerge the laminate for approximately 5 minutes, or longer, and peel off the support paper of the coating.
   D: Peel off the image from the release sheet.
   E: Apply by ironing a piece of a release sheet of paper or plastic, preferably transparent, having its release surface coated with a thin plastic film, with said plastic film in contact with the image.
Step 3: Trim the image.
Step 4: Remove the adhesive liner and position the sheet with the adhesive in contact with the desired surface. Rub over the surface of the transfer.
Step 5: Carefully peel off the release sheet. The adhesive transfer is now completed. If extra strength is desired and if the transfer is made on fabric or other material that may be ironed, keep the release sheet and press the transfer for 30 seconds with the iron at “cotton” temperature. When cool, peel off the release sheet, which should be saved to be used whenever a transfer is being ironed. While pressing with the iron in contact with the transfer provides the best migration of some rubber based adhesives, for rubber based hot melt adhesives, like the S-246, pressing over the fabric side is recommended. This protects the image from becoming overheated during the heat pressing.

For this purpose, a composite sheet consisting of an image absorbing layer, a plastic film and a rubber based hot melt adhesive is provided. The preferred layer is a powder coating of the kinds used for inkjet glossy photo paper, which is 90% opaque white; however, transparent coatings may also be used. Practically any plastic film may be used, e.g. acrylics, polyurethane, polyethylene, vinyl, etc. For transfers to dark substrates, a white plastic film may be used, When the transfer is to be stretchable, a polyurethane film is the preferred material and a breathable version for transfers of tattoos.

As to the adhesive, most contact adhesives may be used for Sheet 1 adhesive application on surfaces which are not to be ironed. Thus, one version of the ST sheet, intended for application of tattoos, may use a micro-pore adhesive. However, as all four sheet may be ironed, rubber based hot melt adhesive is used for the standard versions of all of the four transfer sheets to take advantage of the heat pressing qualities of the adhesive, which are unique. There are thousands of rubber based hot melt adhesives on the market, according to an internet search, and all or most of them will probably work.

The sheets may be mass produced, utilizing inline coating and laminating facilities. However, individual sheets could be coated by a screen printing process and laminated in a heat transfer machine.

The sheets may also be manufactured, utilizing rolls or sheets of paper with image absorbing layers, such as coated printing papers, zinc oxide coated electrostatic copying paper or inkjet glossy photo paper. Accordingly, the coated paper is first laminated with its coated side in contact with a plastic film. The paper is then washed away, leaving the coating adhering to the plastic film surface. Finally, the adhesive is applied on the opposite side of the plastic film.

Sheet 2—A dry release version was tested in this manner. First a rubber based hot melt transfer adhesive was applied on the surface of a polyurethane plastic film. Thereafter, an inkjet glossy photo paper was positioned with its glossy side in contact with the plastic film opposite side. The laminate was next heat pressed, after which the transfer adhesive second liner was peeled off and the laminate positioned with the adhesive in contact with a thin acrylic film which had been coated on the non-coated side of a one-side-coated paper. The laminate was submerged for 30 minutes. It was then removed and the paper bases of the glossy photo paper and the on-side-coated paper were peeled off, leaving the glossy photo paper inkjet receptive coating adhering to the surface of the plastic film, and the adhesive covered by the thin acrylic film. Finally, a silicone coated release paper was positioned with the release layer in contact with the acrylic film and heat pressed, whereby the thin laminate received the required body and became sufficiently straight and level for offset or inkjet printing.

Other features and advantages of the instant invention will become apparent from the following description of the invention which refers to the accompanying drawings.

### BRIEF DESCRIPTION OF THE DRAWINGS

FIG. 1: shows a cross section of Transfer Sheet 1 according to the present invention.

FIG. 2: depicts transfer sheet 1 with an image on its image absorbing layer according to the present invention.

FIG. 3: shows the transfer sheet of FIG. 2 with a removable adhesive film applied over the image according to the present invention.

FIG. 4: shows the lower portions of the laminate of FIG. 3, having the adhesive liner partially removed according to the present invention.

FIG. 5: illustrates the laminate of FIG. 4, having the adhesive liner completely removed according to the present invention.

FIG. 6: shows the laminate of FIG. 5, the removable adhesive film having been removed and the transfer completed according to the present invention.

FIG. 7: depicts a transfer in accordance with FIG. 5, the image having been obtained with water soluble inks according to the present invention.

FIG. 8: illustrates the lower portion of FIGS. 6 and 7 according to the present invention.

FIG. 9: shows the upper portion of the transfer of FIG. 7, having been heat pressed and the seal coated ironing paper peeled off, leaving a waterproof seal coat over the transferred image according to the present invention.

FIG. 10: is a cross section of a Sheet 2 iron-on transfer sheet—wet release in accordance with the present invention.

FIG. 11: is a cross section of a Sheet 2 iron-on transfer—dry release according to the present invention.

FIG. 12: shows the cross section of a decal derived from the transfer sheet of FIG. 10 according to the present invention.

FIG. 13: shows the cross section of a decal derived from the transfer sheet of FIG. 11 according to the present invention.

FIG. 14: shows the lower portion of the cross section of the decals of FIGS. 12 and 13 according to the present invention.

FIG. 15: shows the cross section of an industrial iron-on decal in accordance with the present invention.

FIG. 16: shows the cross section of an industrial decal in accordance with the present invention.

FIG. 17: shows the cross section of the decal of FIG. 16 according to the present invention.

FIG. 18: shows the cross section of the completed transfer of the decal of FIGS. 16 and 17 according to the present invention.

### DETAILED DESCRIPTION OF THE INVENTION

With reference to the Figures, all reference designators referring to the same structure are similarly labeled and will not necessarily be referred to once their function has been described.

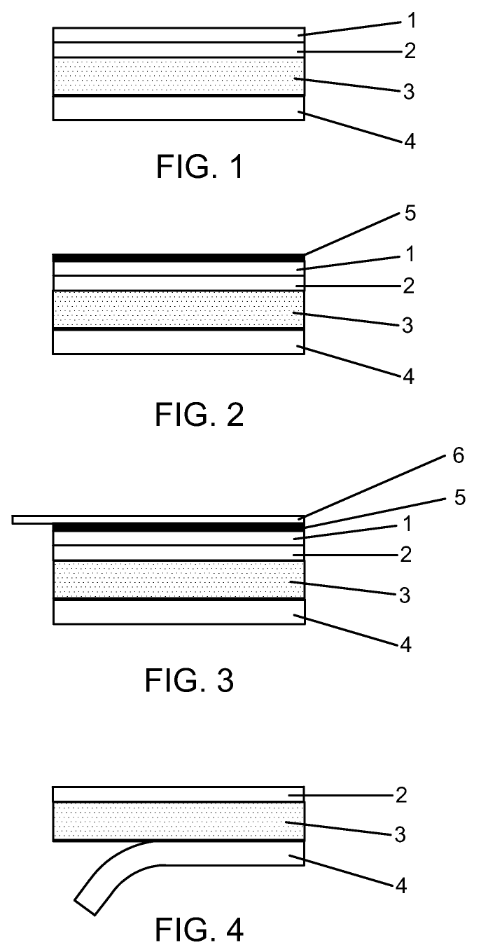

In order to demonstrate that the present invention works, tests run in the laboratory utilized image absorbing layers composed of zinc oxide, printing paper coatings and inkjet glossy paper coatings over the plastic film for sheets A, B and C and a one-side-coated paper with adhesive applied thereon for sheet D. It should be noted, however, that in production of commercial sheets, inkjet and offset receptive layers, which are available in the market, should be used. These layers are applied over the plastic film, or over any other layer that has been applied over the plastic film of sheets A, B and C (FIGS. 1-14) and over the adhesive of sheet D. In respect with sheet D, the coating may also be applied on the non-coated side of an one-side coated paper, or on the release layer of a release sheet, such as a silicone coated paper or polyester sheet and the coated paper applied over the adhesive, as described below in relation to Sheet D (FIGS. 15-18).

Referring to FIG. 1, a cross section of a transfer sheet according to the present invention is shown having an image absorbing layer 1 located on top of a plastic film 2. An opposite side is coated with a contact adhesive 3 and protected by a liner 4. The sheets prepared according to the embodiment shown in FIG. 1 use a 1 mil, or thinner, polyurethane film, such as the film produced by Deerfield Urethane, and a rubber based contact adhesive, such as the S-246 produced by Fasson Roll. The image absorbing layer 1 is made by laminating a coated paper to the plastic film 2, with the coating in contact with the same. For inkjet receptive coatings, the coating of glossy photo papers, manufactured by Seiko Epson or Celadon Plastic Corporation, have been used, and for offset receptive layers, the coating of printing papers, such as the one with double coating produced by Kimiberly Clark, Mexico, or the triple coated paper, produced by the Belgian company Burgo.

The adhesive 3 is next applied over the plastic film opposite side, after which the adhesive liner is peeled off and the laminate submerged. The time of submersion depends on the coating that is being applied. A coated paper for an offset receptive coating needs only 5 minutes of submersion, after which the paper base may be peeled off, leaving the coating adhering to the plastic film. A glossy photo paper, on the other hand, has to be submerged for half an hour, before its paper base can be peeled off. When the laminate is removed, the adhesive is weak, due to the submersion. It is wiped dry with care and, thereafter, the laminate is placed with the adhesive in contact with a release sheet and the paper base of the coated paper peeled off.

The laminate is then left to dry, after which it is heat pressed at low temperature and with little pressure in order to keep it straight and level. The laminate so obtained by the process described may then be laminated to a sheet of paper to allow printing in a printer such as an Epson Stylus CX5400, or a HP DeskJet 840 C. The resultant sheets have been tested in these printers, and have all proved to function in accordance with the invention.

In production, laminates would be given more body, either by using a liner 4 with a card paper base, or by laminating a paper over the liner 4. The thickness of the adhesive layer 3 may also be varied, as may the thickness of the plastic film 2 and the image absorbing layer 1.

With reference to FIG. 2, an image 5 is applied to the image absorbing layer 1 of the transfer sheet laminate. During the experiments, the two printers, mentioned above, were used. The images of one of these printers had been advertised to be waterproof. In reality, the inks available in Mexico, where the inks were purchased, are not waterproof, and prints made on triple coated paper dissolve instantly, if submerged in water. Notwithstanding, the prints obtained in this printer on the inkjet receptive coating, derived from lamination of a glossy photo paper, absorb sufficiently well for the print to become fully machine washable, following the heat pressing described in FIG. 8; however, prints from most inkjet printers are water soluble and need a seal coating in order to become machine washable, also described in FIG. 8.

Referring now to FIG. 3, the transfer sheet is shown having an Application Film 6 with removable adhesive applied over the image 5. In tests with Sheet 1, a Frisk Film, a low tack soft peel masking film, produced and marketed globally by a company named Artool, has been used as Application Film 6 with good results. The film is applied with the low tack adhesive in contact with the image, overlapping one of the edges, usually the front edge, by approximately ¼″ (6 mm). The film is rubbed in order to obtain good adhesion all over, and especially over the edges of the laminate.

Referring to FIG. 4, the liner 4 has been separated from the adhesive and partly removed. This step is best done by first turning the laminate upside down and rubbing over the edge of the liner opposite the overlapping Application Film 6. With a suitable release force of the liner 4, it may be separated from the adhesive by gently pressing down the overlapping strip of the Application Film 6. The liner 4 is then carefully pulled back, as shown in the figure.

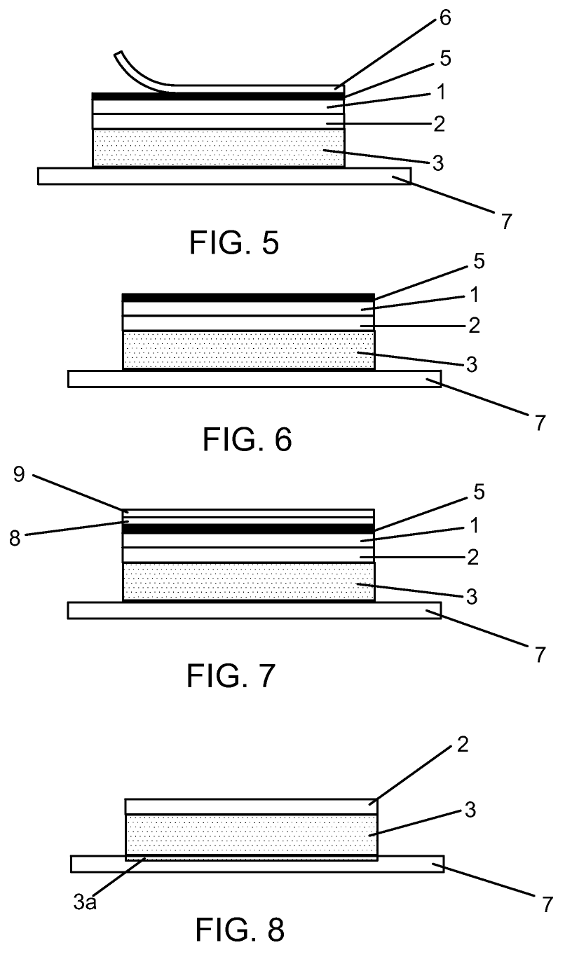

Referring to FIG. 5, the liner 4 has been peeled off and discarded, and the laminate positioned with the adhesive in contact with the desired substrate 7. In order to secure good contact, the transfer should be rubbed all over and especially over the edges. The Application Film 6 may then be peeled off with care. The figure shows the initiation of the Application Film 6 removal.

Referring to FIG. 6, the Application Film 6 has been completely removed and discarded. The adhesive transfer is now completed. However, if applied on a substrate 7 that will be machine washed, it must also be heat pressed, as shown in FIG. 8.

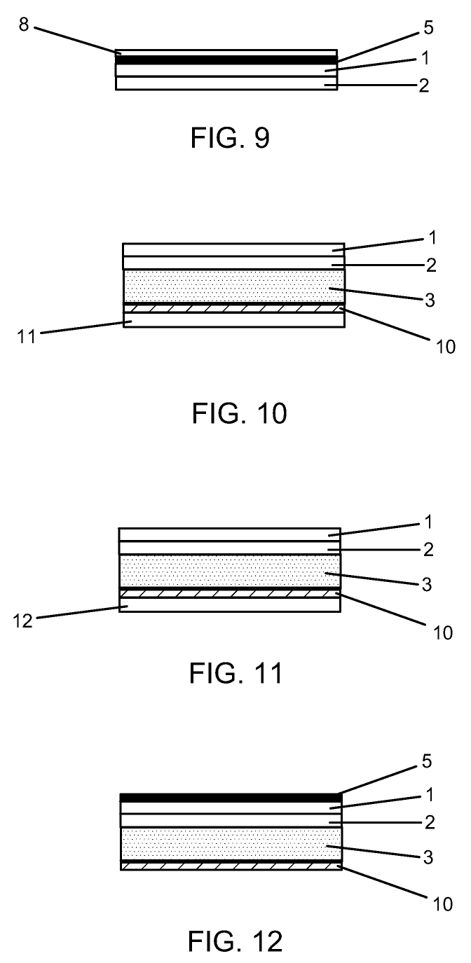

Referring to FIG. 7, the adhesive transfer has been completed of an image obtained with water soluble inks. If the transfer is applied on a surface which is to be machine washed, the transferred image has to be sealed. This is done by covering the transferred image with a release sheet, coated with a suitable sealing layer, such as a thin layer of polyurethane. Accordingly, the release sheet 9 is positioned with seal coating 8 in contact with the transferred image. The transfer is, thereafter, heat pressed, as shown in FIGS. 8 and 9.

Referring to FIG. 8, showing the lower parts of the transfers depicted in FIGS. 6 & 7, after having been pressed for 30 seconds with the iron at “cotton” temperature. This causes the adhesive 3 to expand and migrate into the cross section of the substrate 7, as indicated by layer 3a.

Referring to FIG. 9, which shows the upper portion of the transfer of the laminate of FIG. 7, following the heat pressing, the release sheet 9 has been peeled off and discarded, leaving the seal coating 8 fused to the image and protecting the same during submersion and machine washing.

Referring to FIG. 10, the cross section of Sheet 2—wet release, is shown. The image absorbing layer 1, the plastic film 2 and the adhesive layer 3 are the same as those of Sheet 1, though the thickness of the layers may vary. The adhesive layer 3 is covered by a coated printing paper 11, such as the Kimberly Clark printing paper with double coating, with the coating 10 in contact with the adhesive layer 3.

Referring to FIG. 11, the cross section of Sheet 2—dry release, is shown. The image absorbing layer 1, the plastic film 2 and the adhesive layer 3 is the same as those of Sheet 1, though the thickness of the layers may vary, the adhesive layer 3 is covered by the coating 10, adhering to the release layer of a release paper 12.

Referring to FIG. 12, the cross section of a decal, obtained with Sheet 2—wet release, is shown. An image 5 was first printed on the transfer sheet image absorbing layer 1. The printed sheet was then submerged for 5 minutes, after which it was taken up and the coated printing paper 11 peeled off, leaving the coating 10 adhering to the adhesive layer 3 and covering the same.

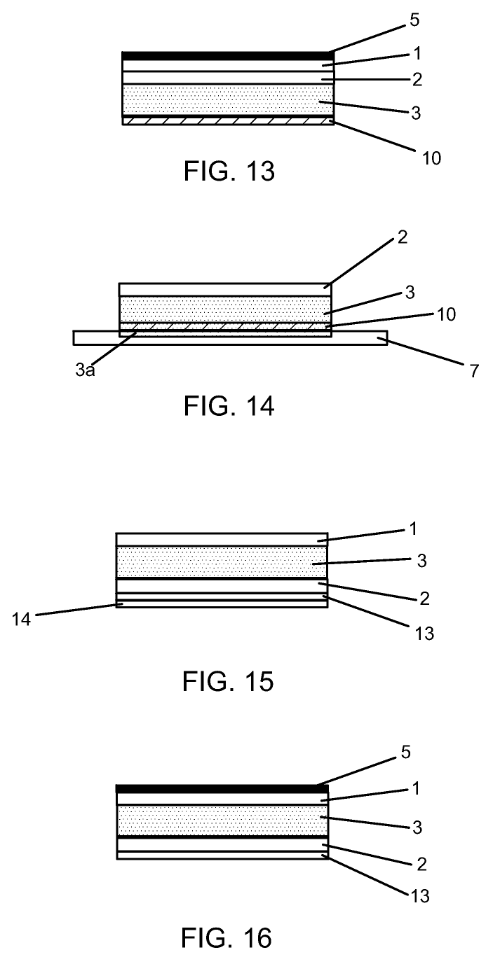

Referring to FIG. 13, the cross section of a decal, obtained with Sheet 2—dry release, is shown. An image 5 was first printed on the transfer sheet image absorbing layer 1. The release paper 12 was then peeled off, leaving the coating 10 adhering to the adhesive layer 3 and covering the same.

FIG. 14 shows the lower portion of the decals of FIGS. 12 and 13 after completion of the transfer. Based on experience from transfers in accordance with my non-provisional patent applications, the documented ability of a heated rubber based hot melt adhesive, combined with a polyurethane film, to migrate and penetrate printed and copied image layers, as well as layers of paper surface coatings, and is utilized. Experiments to find suitable layers for a dry release coating of the adhesive showed that thin films of acrylics and plastisol could be utilized. The zinc oxide coating of an electrostatic copying paper does also work well.

However, these papers are difficult to obtain today, as most copying is done by photocopying. Furthermore, while the thickness of an acrylic or plastisol layer is easy to adjust, for instance by coating in a screen printing press, the thickness of zinc oxide layers of mass produced zinc oxide coated papers cannot be changed. As migration through a zinc oxide layer of the available thickness requires a heavier adhesive layer than migration through a thin acrylic or plastisol layer, the latter layers are preferred. The figure shows the migration and penetration of the adhesive through the covering layer 10 into the substrate 7, providing the transfer with an anchorage layer 3a.

FIG. 15 shows the cross section of Sheet 4, mainly intended for industrial transfers. The image absorbing layer 1 is located over the adhesive 3, which is combined with the plastic film 2. In view of the fact that the composite layer, made up of these layers, is very thin, a support sheet 13 with a release layer 14 has been applied over the plastic film 2 This support sheet 13 may be a silicone coated sheet; the release layer 14 being a silicone coating, and the paper 13, a base paper. During tests, various silicone coated papers were tried, in order to find one with the right release force and rigidity to be printed in an offset press or computer printer. The sheets used in the test were produced by the Mexican company Papeles Sensibilizados, S. A. de C. V. While one of these papers worked very well, it is quite possible that for production, a silicone coated polyester sheet will be used.

FIG. 16 shows a cross section of the industrial transfer sheet shown in FIG. 15, a reverse image 5 having been printed on the image absorbing layer 1. With the previous three sheets, it is possible to use an image absorbing layer 1 which is white or semi white, except when transparency is required. On this sheet, the image absorbing layer 1 has to be completely transparent, because the image will be seen from the opposite side. There are many known ways of applying a transparent image absorbing layer 1 over the adhesive layer 3. In experiments to prove the feasibility of this process, a thin acrylic film was applied to the non coated side of a one-side-coated paper. A layer of adhesive, combined with a plastic film was then applied over the acrylic film, and the one-side-coated paper's paper base washed away.

The resultant surface was clear and not sticky though it was not a real inkjet receptive surface. Notwithstanding, even if the image was not as good as with a real receptive surface, it was possible to print on it and prove this kind of transfer sheet was usable. The acrylic layer with the surface covered with residue from the one-side-coated paper base representing the image of sorting layer 1. Accordingly, the thin composite sheet was attached to a printing paper with adhesive tape over the edges, and a reverse image printed on its surface in an Epson Stylus CX5400 printer, using the lowest ink setting, (a previous test with standard ink setting resulted in a print with excess ink that smudged the edges). The transfer sheet was, thereafter, positioned with the printed, reverse image, in contact with a piece of T-shirt cotton, covered by a silicone coated ironing parchment, and pressed for 30 seconds with the iron at “cotton” temperature. The adhesive migrated through the acrylic film and through the image layer, into the fabric, giving the transferred image a good anchorage.

FIG. 16 represents the sheet used for the experiment. The image absorbing layer 1, obtained when the paper was washed away, is symbolic of a production inkjet or offset receptive coating. The image layer 5 is the cross section of the image obtained in the CX5400 printer, the adhesive layer 3 is the cross section of the adhesive and the plastic film layer 2, the polyurethane film. The first test sheet didn't have a support sheet 13, shown in the figure. However, when the decal was covered with an ironing parchment, the cross section represented the one show in FIG. 16.

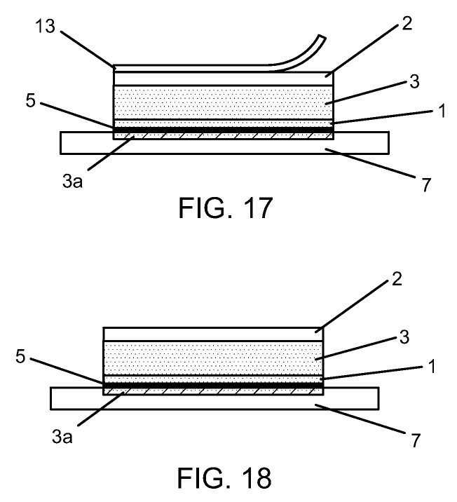

FIG. 17 shows the cross section of the decal of FIG. 16, having been ironed-on to the substrate 7. The adhesive layer 3 has expanded and migrated through the image absorbing layer 1 consisting of the thin acrylic layer and the residue of the one-side-coated paper. It has, furthermore, penetrated the image layer 5, as well as the surface of the substrate 7, forming the anchorage layer 3a. The ironing paper, representing the support sheet 13 of production transfer sheets, adheres to the plastic film 2 until cool, when it may be peeled off, the initial stage of which is indicated in the figure.

FIG. 18 shows the completed transfer, the support paper having been peeled off. In the case of the laboratory test, it was the ironing parchment that was peeled off. The transfer, while passing a machine washing test, was a bit weak, probably due to the fact that a standard adhesive with a thickness of 2 mil was not sufficient to penetrate very well through the layers mentioned. For this reason, another test was made with a double layer of adhesive. This transfer was very strong.

While the standard transfers made with the described industrial sheets are intended for application on light surfaces, the sheets may also be used for application on dark surfaces. When used in this configuration, the image should be printed with a white ink layer covering the same. It is also possible to add a white background layer, by painting a thin layer over the image, prior to the transfer.

### EXAMPLE 1

### An Art Reproduction Applied to Canvas, Using Sheet 1

A reproduction of a painting was scanned and printed on a Sheet 1 in an Epson Stylus CX5400 multiuse Printer. The printed image was cut out and an Application Sheet was applied over the printed image. The laminate was rubbed thoroughly, after which it was turned over. After rubbing over the front edge of the liner, it was separated from the adhesive and the laminate positioned with the adhesive surface in contact with the canvas. The transfer was rubbed all over, after which the Application Sheet was peeled off. The transfer was now completed.

### EXAMPLE 2

### Colored Pictures Transferred to T-shirt, Using Sheet 1

A school class was to have a logo printed on the breast pocket of their T-shirts and a competition of the best design was announced. Participants prepared logos, using Sheet 1, and presented these to the jury, who selected the winner. All students, except the winner, washed their T-shirts and peeled off their designs. They then applied the winning design and, like the winner, pressed their transfers for 30 seconds with the iron at “cotton” temperature, thereby making the logo machine washable and permanently transferred painting providing a manner of integrating it with the fabric for many years of use.

### EXAMPLE 3

### Transfer of a Picture Obtained on the Internet, Using Sheet 2

A color picture was obtained on the internet and printed on Sheet 2 in a printer with waterproof inks. The picture was cut out and, thereafter, submerged for 5 minutes, after which it was taken up and its paper base peeled off. The resultant decal was positioned on a T-shirt and pressed for 30 second with the iron at “cotton” temperature. After a few minutes of cooling, the machine washable transfer was completed.

### EXAMPLE 4

### Transfer of Pictures Copied on Sheet 3 in a Printer with Waterproof Inks

Color pictures were copied and printed on Sheet 3 in a printer with waterproof inks. Following dye cutting, the image were positioned on T-shirts and pressed for 20 seconds at “cotton” temperature. When cool, each transfer was completed.

### EXAMPLE 5

### Transfer of a Picture Printed with Water Soluble Inks on Sheet 3

A color picture was printed on Sheet 3 in a printer with water soluble inks. The print was cut out and placed on a blouse, covered with a Seal Coating release paper. It was then pressed for 30 seconds with the iron at “cotton” temperature. When cool, the Seal Coating paper was peeled off, leaving the transferred image covered by a thin seal coating, making it machine washable.

### EXAMPLE 6

### Printing of Pictures of Election Candidates on T-Shirts Using Sheet 4

Reverse prints were made in offset in large quantities on Sheet 4. The sheets were first dye cut, and then positioned with the printed images in contact with the T-shirts. The T-shirts were then positioned on the pressing platform of a heat transfer machine, covered with silicone coated ironing parchments and pressed for 20 seconds at a temperature of 180 C. When cool, the ironing paper was removed. The transfers had been completed.

Although the instant invention has been described in relation to particular embodiments thereof, many other variations and modifications and other uses will become apparent to those skilled in the art.

What is claimed is:

1. A rubber-based hot melt adhesive image transfer sheet comprising:
a first image absorbing layer having an image top and an image bottom surface;
a second plastic film layer having a film top and a film bottom surface;
said film top surface contacting and coplanar with said image bottom surface;
a third rubber-based hot melt adhesive layer having an adhesive top and an adhesive bottom surface;
said adhesive top surface contacting and coplanar with said film bottom surface;
a fourth protective liner layer having a liner top and a liner bottom surface; and
said liner top surface contacting and coplanar with said adhesive bottom surface.

2. The rubber-based hot melt adhesive image transfer sheet of claim 1 wherein said first image absorbing layer is a coated paper.

3. The rubber-based hot melt adhesive image transfer sheet of claim 1 wherein said second plastic film layer is polyurethane.

4. The rubber-based hot melt adhesive image transfer sheet of claim 2 wherein said coated paper is coated with zinc oxide.

5. The rubber-based hot melt adhesive image transfer sheet of claim 1 wherein said first image absorbing layer is white.

6. The rubber-based hot melt adhesive image transfer sheet of claim 1 wherein said first image absorbing layer is transparent.

7. The rubber-based hot melt adhesive image transfer sheet of claim six wherein said first image absorbing layer is an acrylic film.

8. A rubber-based hot melt adhesive image transfer sheet comprising:
a first image resorting layer having an image top and an image bottom surface;
a second plastic film layer having a film top and a film bottom surface;
said film top surface contacting and coplanar with said image bottom surface;
a third rubber-based hot melt adhesive layer having an adhesive top and an adhesive bottom surface;
said adhesive top surface contacting and coplanar with said film bottom surface
a fourth coating layer having a coating top surface and a bottom surface; and
said coating top surface contacting and coplanar with said adhesive bottom surface.

9. An image transfer sheet comprising:
a first image absorbing layer having an image top and an image bottom surface;
a second rubber-based hot melt adhesive layer having an adhesive top and an adhesive bottom surface;
said adhesive top surface contacting and coplanar with said image bottom surface;
a third plastic film layer having a film top layer and a film bottom layer;
said film top surface contacting and coplanar with said adhesive bottom surface;
a fourth supporting liner layer having a liner top and a liner bottom surface; and
said liner top surface contacting and coplanar with said plastic film bottom surface.
